(19) United States
(12) Patent Application Publication
(10) Pub. No.: US 2023/0343148 A1
(43) Pub. Date: Oct. 26, 2023

(54) Method of Digging Valuable Data and Server Using the Same

(71) Applicant: Shenzhen Guodong Technology Company Limited, Shenzhen (CN)

(72) Inventor: Jianxiong XIAO, Shenzhen (CN)

(73) Assignee: Shenzhen Guodong Technology Company Limited, Shenzhen (CN)

(21) Appl. No.: 18/302,802

(22) Filed: Apr. 19, 2023

(30) Foreign Application Priority Data
Apr. 21, 2022 (CN) 202210422034.4

(51) Int. Cl. G07C 5/00; G07C 5/08

(52) U.S. Cl. CPC G07C 5/008; G07C 5/0841

(57) ABSTRACT

A method of digging valuable data and a server using the same are provided. The method comprises steps of: grabbing source data of one or more regions within a period of time, the source data of one or more autonomous driving vehicles within a period of time, and the source data of one or more sensors within a period of time from the storage area in parallel to form several initial data packets; analyzing corresponding data in each initial data packet to obtain abnormal data; adding labels to the abnormal data to form first version data packets; adding labels to data associated with label requests in some of the initial data packets to form second version data packets; analyzing the data analysis requests in parallel to obtain corresponding labels; obtaining data from the first version data packets and/or the second version data packets in parallel to be valuable data.

### CROSS REFERENCE TO RELATED APPLICATION

This non-provisional patent application claims priority under 35 U.S.C. § 119 from Chinese Patent Application No. 202210422034.4 filed on Apr. 21, 2022, the entire content of which is incorporated herein by reference.

### TECHNICAL FIELD

The disclosure relates to the field of autonomous driving technology, and in particular to a method of digging valuable data and a server using the same.

### BACKGROUND

Nowadays, autonomous driving technology is showing an explosive growth trend. With continues expansion of application field of autonomous driving technology, various sensors, as the key basis to support autonomous driving technology, need to conduct a large amount of data processing and training on massive autonomous driving data to continuously improve ability of autonomous AI drivers.

However, when extracting the autonomous driving data, it is necessary to traverse all the autonomous driving data each time to extract corresponding data. In this way, autonomous driving system needs to consume a lot of computing power, resulting in low efficiency.

### SUMMARY

The disclosure provides a method of digging valuable data and a server using the same, the method can dig the valuable data efficiently.

A first aspect of the disclosure provides a method of digging valuable data, applying to an autonomous driving system, the autonomous driving system comprises a plurality of autonomous driving vehicles, and the method of digging valuable data includes the steps of: receiving source data sent by all the autonomous driving vehicles of the autonomous driving system, and storing the source data in storage area, the source data comprising collecting data collected by all the autonomous driving vehicles, running status data generated by all the autonomous driving vehicles during road testing, and processing data calculated by all the autonomous driving vehicles, the collecting data being collected by multiple sensors of each autonomous driving vehicle, the source data from different sources having different data structure attributes, the data structure attributes including source information of data, the source information of data including area identifier indicating geographic area of the autonomous driving vehicles, vehicle identifier indicating identity of the autonomous driving vehicles, sensor identifier indicating identity of the sensors, and timestamp of the source data; grabbing the source data of one or more regions within a period of time, the source data of one or more autonomous driving vehicles within a period of time, and the source data of one or more sensors within a period of time from the storage area in parallel to form several initial data packets, according to the source information of data and multiple preset extraction instructions; analyzing corresponding data in each initial data packet to obtain abnormal data; adding labels to the abnormal data to form first version data packets, each of the first version data packets includes a first timestamp; when receiving label requests sent by one or more clients, adding labels to data associated with the label requests in some of the initial data packets to form second version data packets, according to the label requests, each of the second version data packets includes a second timestamp, the second timestamp indicating time of adding labels to the some of the initial data packets; when receiving data analysis requests sent by one or more clients, analyzing the data analysis requests in parallel to obtain corresponding labels, the data analysis requests including presentation information of the labels; and obtaining data from the first version data packets and/or the second version data packets in parallel to be valuable data according to the labels obtained.

A second aspect of the disclosure provides a server of digging valuable data, the server of digging valuable data comprises: a memory configured to store program instructions and a processor configured to execute the program instructions to enable the server to perform a method of digging valuable data, wherein the method applies to an autonomous driving system, the autonomous driving system comprises a plurality of autonomous driving vehicles, and the method of digging valuable data comprises the steps of: receiving source data sent by all the autonomous driving vehicles of the autonomous driving system, and storing the source data in storage area, the source data comprising collecting data collected by all the autonomous driving vehicles, running status data generated by all the autonomous driving vehicles during road testing, and processing data calculated by all the autonomous driving vehicles, the collecting data being collected by multiple sensors of each autonomous driving vehicle, the source data from different sources having different data structure attributes, the data structure attributes including source information of data, the source information of data including area identifier indicating geographic area of the autonomous driving vehicles, vehicle identifier indicating identity of the autonomous driving vehicles, sensor identifier indicating identity of the sensors, and timestamp of the source data; grabbing the source data of one or more regions within a period of time, the source data of one or more autonomous driving vehicles within a period of time, and the source data of one or more sensors within a period of time from the storage area in parallel to form several initial data packets, according to the source information of data and multiple preset extraction instructions; analyzing corresponding data in each initial data packet to obtain abnormal data; adding labels to the abnormal data to form first version data packets, each of the first version data packets includes a first timestamp; when receiving label requests sent by one or more clients, adding labels to data associated with the label requests in some of the initial data packets to form second version data packets, according to the label requests, each of the second version data packets includes a second timestamp, the second timestamp indicating time of adding labels to the some of the initial data packets; when receiving data analysis requests sent by one or more clients, analyzing the data analysis requests in parallel to obtain corresponding labels, the data analysis requests including presentation information of the labels; and obtaining data from the first version data packets and/or the second version data packets in parallel to be valuable data according to the labels obtained.

A third aspect of the disclosure provides a system of digging valuable data, the system of digging valuable data comprises: a plurality of autonomous driving vehicles and a server, wherein the server comprises a memory configured to store program instructions and a processor configured to execute the program instructions to enable the server to perform a method of digging valuable data, and the method of digging valuable data comprises the steps of: receiving source data sent by all the autonomous driving vehicles of the autonomous driving system, and storing the source data in storage area, the source data comprising collecting data collected by all the autonomous driving vehicles, running status data generated by all the autonomous driving vehicles during road testing, and processing data calculated by all the autonomous driving vehicles, the collecting data being collected by multiple sensors of each autonomous driving vehicle, the source data from different sources having different data structure attributes, the data structure attributes including source information of data, the source information of data including area identifier indicating geographic area of the autonomous driving vehicles, vehicle identifier indicating identity of the autonomous driving vehicles, sensor identifier indicating identity of the sensors, and timestamp of the source data; grabbing the source data of one or more regions within a period of time, the source data of one or more autonomous driving vehicles within a period of time, and the source data of one or more sensors within a period of time from the storage area in parallel to form several initial data packets, according to the source information of data and multiple preset extraction instructions; analyzing corresponding data in each initial data packet to obtain abnormal data; adding labels to the abnormal data to form first version data packets, each of the first version data packets includes a first timestamp; when receiving label requests sent by one or more clients, adding labels to data associated with the label requests in some of the initial data packets to form second version data packets, according to the label requests, each of the second version data packets includes a second timestamp, the second timestamp indicating time of adding labels to the some of the initial data packets; when receiving data analysis requests sent by one or more clients, analyzing the data analysis requests in parallel to obtain corresponding labels, the data analysis requests including presentation information of the labels; and obtaining data from the first version data packets and/or the second version data packets in parallel to be valuable data according to the labels obtained.

The method of digging valuable data and the server using the same, obtain data from the storage area of the source data by the preset extraction instructions. Abnormal data is filtered from the data and the abnormal data is labeled, time of tagging label is attached to the abnormal data at the same time. The abnormal data is input into the preset algorithm model for calculating, and the valuable data is obtained finally. The method of digging valuable data can grab data directly from massive autonomous driving data efficiently by time, or name of event, or the time and the name of event, and also reduce large amount of computing power of the autonomous driving system.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 illustrates a flow diagram of a method of digging valuable data in accordance with a first embodiment.

FIG. 2 illustrates a flow diagram of a method of digging valuable data in accordance with a second embodiment.

FIG. 3 illustrates a flow diagram of a method of digging valuable data in accordance with a third embodiment.

FIG. 4 illustrates a sub flow diagram of a method of digging valuable data in accordance with the second embodiment.

FIG. 5 illustrates a sub flow diagram of a method of digging valuable data in accordance with the third embodiment.

FIG. 6 illustrates a schematic diagram of a server of digging valuable data in accordance with an embodiment.

FIG. 7 illustrates a schematic diagram of a storage area of source data in accordance with an embodiment.

FIG. 8 illustrates a schematic diagram of an autonomous driving system in accordance with an embodiment.

FIG. 9 illustrates a schematic diagram of obtaining data packets paralleling in accordance with an embodiment.

### DETAILED DESCRIPTION OF THE EMBODIMENTS

In order to make purpose, technical solution and advantages of the disclosure more clearly, the disclosure is further described in detail in combination with drawings and embodiments. It is understood that the specific embodiments described herein are used only to explain the disclosure and are not used to define it. On the basis of the embodiments in the disclosure, all other embodiments obtained by ordinary technicians in this field without any creative effort are covered by protection of the disclosure.

Terms “first”, “second”, “third”, “fourth”, if any, in specification, claims and drawings of this application are used to distinguish similar objects and need not be used to describe any particular order or sequence of priorities. It should be understood that data are interchangeable when appropriate, in other words, the embodiments described can be implemented in order other than what is illustrated or described here. In addition, terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that description refers to “first”, “second”, etc. in the disclosure are for descriptive purpose only and neither be construed or implied relative importance nor indicated as implying number of technical features. Thus, feature defined as “first” or “second” can explicitly or implicitly include one or more features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the disclosure.

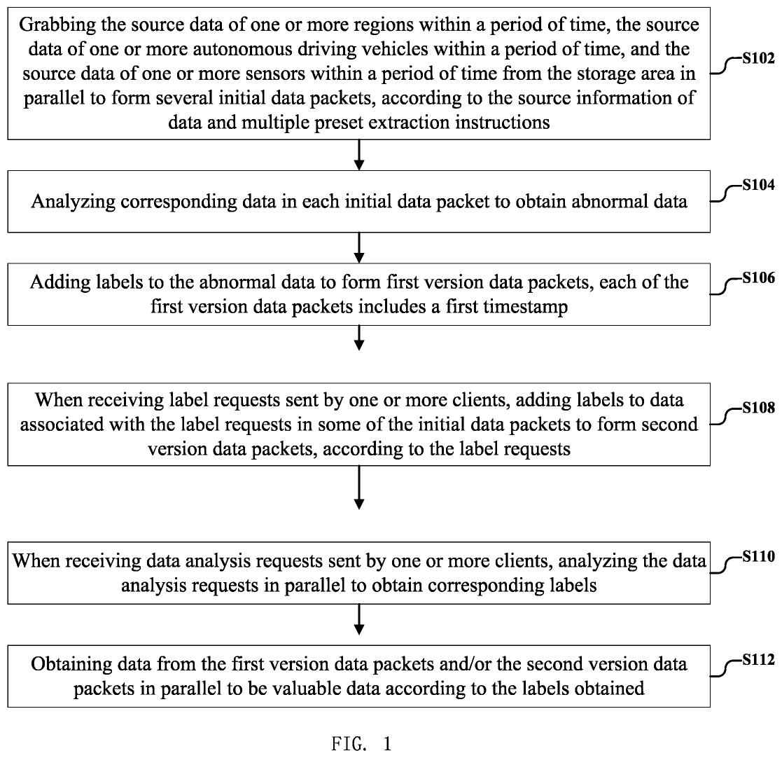

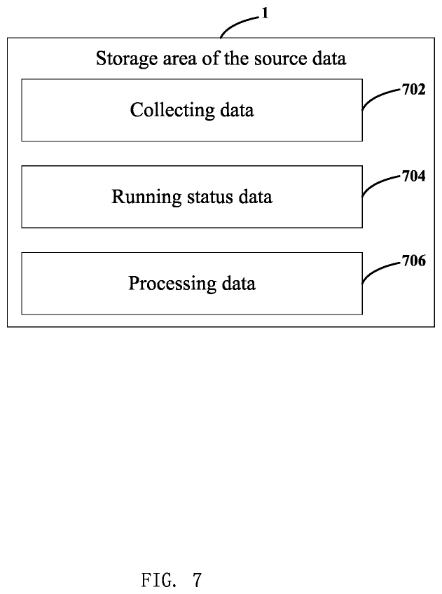

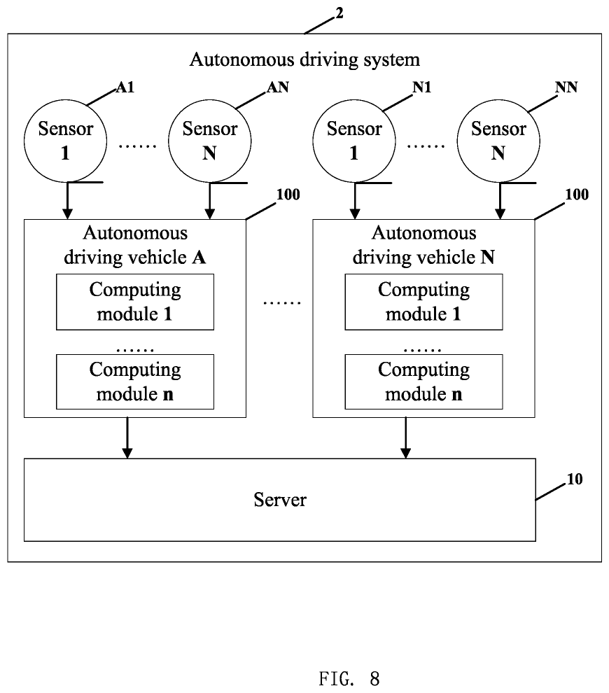

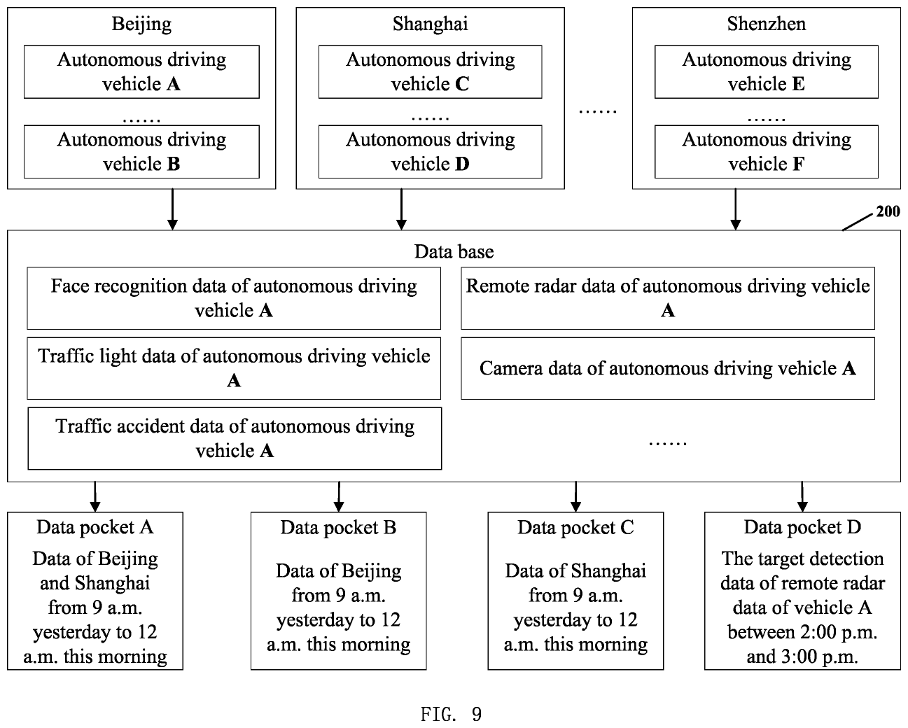

Referring to FIG. 1, FIG. 7, FIG. 8 and FIG. 9, FIG. 1 illustrates a flow diagram of a method of digging valuable data in accordance with a first embodiment, FIG. 7 illustrates a schematic diagram of a storage area of source data in accordance with an embodiment, FIG. 8 illustrates a schematic diagram of an autonomous driving system in accordance with an embodiment, FIG. 9 illustrates a schematic diagram of obtaining data packets paralleling in accordance with an embodiment. The autonomous driving system 2 includes server 10 and vehicles 100. Each vehicle 100 has multiple sensors and multiple computing modules. In this embodiment, source data is received by all the autonomous driving vehicles of the autonomous driving system 2, and the source data is stored in storage area 1 of the source data. The storage area 1 of the source data is the storage area of database 200. The source data comprises collecting data 702 collected by all the autonomous driving vehicles, running status data 704 generated by all the autonomous driving vehicles during road testing, and processing data 706 calculated by all the autonomous driving vehicles. The collecting data is collected by multiple sensors of each autonomous driving vehicle. The source data from different sources has different data structure attributes, the data structure attributes include source information of data. The source information of data includes area identifier indicating geographic area of the autonomous driving vehicles, vehicle identifier indicating identity of the autonomous driving vehicles, sensor identifier indicating identity of the sensors, and timestamp of the source data.

Take autonomous driving vehicle A and N as an example, data collected by multiple sensors A1-AN of the autonomous driving vehicle A and data calculated by multiple computing modules 1-n of the autonomous driving vehicle A are transmitted in parallel to server 10 for storage in the storage area 1 of source data. Similarly, data collected by multiple sensors N1-NN of the autonomous driving vehicle N and data calculated by multiple computing modules 1-n of the autonomous driving vehicle N are transmitted parallel to server 10 for storage in the storage area 1 of source data.

Understandably, sensor data structure varies from type to type or manufacturer. Likewise, the computing modules on different vehicles will result in different data structures depending on type and manufacturer. In other words, data obtained by all autonomous driving vehicles of the autonomous driving system will be transmitted to server 10 for storage, thus forming massive data sources and providing data basis for subsequent autonomous driving simulation or model training and deep learning.

The method of digging valuable data comprises the following steps.

In step S102, according to the source information of data and multiple preset extraction instructions, the source data of one or more regions within a period of time, the source data of one or more autonomous driving vehicles within a period of time, and the source data of one or more sensors within a period of time are grabbed in parallel from the storage area 1 of source data to form several initial data packets. The several initial data packets include area initial data packets, vehicle initial data packets and sensor initial data packets. The area initial data packets, the vehicle initial data packets and the sensor initial data packets are expressed by storage path IDs of the source data. Each the storage path ID of the source data includes source data storage path ID of the sensor, or processing data storage path ID of the vehicle.

The area initial data packets, the vehicle initial data packets and the sensor initial data packets have storage path IDs. And the area initial data packets, the vehicle initial data packets and the sensor initial data packets store corresponding source data respectively.

For example, as shown in FIG. 9, the preset extraction instruction is to extract data of Shanghai and Beijing from 9 a.m. yesterday to 12 a.m. this morning. According to the preset extraction instruction, regions are selected as Beijing and Shanghai from the source information of data, the timestamp of the source data is from 9 a.m. yesterday to 12 a.m. this morning. Data meeting the conditions is extracted to from first set of data, and the first set of data is packaged as data packet A. The data packet A is the data summary of Beijing and Shanghai from 9 a.m. yesterday to 12 a.m. this morning. If the preset extraction instruction is to extract the data of Shanghai and Beijing from 9 a.m. yesterday to 12 a.m. this morning, and extract the data separately according to different regions. Then two sets of data are extracted according to different regions. The two sets of data are packaged divided into data packet B and data packet C. The data packet B is the data of Beijing from 9 a.m. yesterday to 12 a.m. this morning. The data packet C is the data of Shanghai from 9 a.m. yesterday to 12 a.m. this morning.

For example, according to the preset extraction instruction, target detection data of remote radar of vehicle A from 2:00 p.m. to 3:00 p.m. is to be obtained. The vehicle identification is selected as Vehicle A from the source information of data according to the preset extraction instruction, and the timestamp of the source data is from 2:00 p.m. to 3:00 p.m. . The sensor as the remote radar is taken as data extraction conditions, and data meeting the conditions is extracted to form second set of data. The second set of data is packaged as data packet D. The data packet D is the target detection data of remote radar of vehicle A between 2:00 p.m. and 3:00 p.m. .

The above process of obtaining data is in parallel. That is to say, although data of the data source is massive, analysis of the data only needs to analyze data related to purpose of data analysis. If massive source data is calculated one by one each time, the computing power of server 10 is very high, and the efficiency is very low. In this embodiment, the massive source data can be packaged according to the preset extraction instructions set by users, and only data in associated with data packets need to be analyzed in process of data analysis. Thus, amount of data in the process of data analysis is greatly reduced, and the computing power of the server 10 is greatly reduced too. Also, analysis efficiency is improved.

In step S104, corresponding data in each initial data packet is analyzed to obtain abnormal data. In this embodiment, the server 10 automatically filters the abnormal data based on preset rules. When analyzing the abnormal data, local abnormal data can be obtained after global analysis of a piece of data. For example, traffic light data during time interval T can be analyzed, in which the time interval T includes time period T1. If there is a difference between traffic light data during time period T1 and traffic light data during other time periods of the time interval T, the traffic light data during time period T1 is considered abnormal.

When analyzing abnormal data, a piece of data can be analyzed segment by segment, and data with abrupt changes can be regarded as the abnormal data. For example, data with abrupt changes caused by traffic accidents are regarded as the abnormal data. When analyzing abnormal data, data with information interruption in a piece of data can also be regarded as the abnormal data. For example, if the sensors fail to collect data and information interruption is occurred, the data is regarded as the abnormal data.

In step S106, labels are added to the abnormal data to form first version data packets. Each of the first version data packets includes a first timestamp. In this embodiment, the server 10 automatically adds labels to the abnormal data based on preset label adding rules. The first version data packets can be formed by adding timestamps and event labels to the abnormal data according to time. For example, when an abnormal data is related to traffic lights, a traffic light fault label can be added to the abnormal data to form the first version data packet. When an abnormal data is related to a traffic accident, a traffic accident label can be added to the abnormal data to form the first version data packet.

In step S108, when receiving label requests sent by one or more clients, according to the label requests, labels are added to data associated with the label requests in some of the initial data packets to form second version data packets. Each of the second version data packets includes a second timestamp, the second timestamp indicating time of adding labels to the some of the initial data packets. In this embodiment, the labels can be added manually by the users.

When a traffic accident occurs in a region within a time range, users can add traffic accident labels to the data of vehicles within the region during the time range. After labels are added by the users, the autonomous driving system adds accident labels to corresponding data of the data packets according to the labels added by the users, so as to form the second version data packets. The time when the labels were manually added is used as the timestamp of the second version data packets.

That is to say, this embodiment not only packets the data, but also allows the users to labeled the data according to scenario or the data of subsequent attention, so as to generate a new version of the data packets. When analyzing data packets, users can choose the latest version of data packets or the original version of data packets, which greatly simplifies selection efficiency of data sources for data analysis and further saves the computing power of server 10.

In step S110, when receiving data analysis requests sent by one or more clients, the data analysis requests are analyzed in parallel to obtain corresponding labels. The data analysis requests include presentation information of the labels. That is, multiple data analysis requests can be processed in parallel.

For example, when user A sends a traffic light fault data analysis request while user B sends a traffic accident data analysis request, server 10 can process the data analysis request of user A and user B in parallel to get the labels of traffic light fault and traffic accident contained in the data analysis requests respectively.

In step S112, data is obtained from the first version data packets and/or the second version data packets in parallel to be valuable data according to the labels obtained. The data analysis requests include requests to extract data from vehicles in one area, requests to obtain data from multiple vehicles, requests to obtain data from multiple computing modules of a vehicle, and requests to obtain data from multiple sensors of a vehicle.

Corresponding storage path IDs of the source data is obtained according to the labels. Corresponding data from the first version data packets or the second version data packets is obtained according to the storage path IDs of the source data.

The valuable data required by different data analysis requests from one or more data packets is obtained at the same time, and the valuable data is sent to corresponding clients.

When the server 10 analyzes that the data users need to analyze includes traffic light fault data and traffic accident data, the server 10 can obtain data about traffic light fault and traffic accident data in parallel. The data can be obtained from the first version data packets, from the second version data packets, or from the first version data packets and the second version data packets.

In this embodiment, massive data is packaged into data packets, and the data can be obtained from corresponding data packets according to the needs of the users. In other words, server 10 can access the corresponding data packets in parallel to obtain valuable data, thus greatly improving efficiency of data acquisition.

In the above embodiment, the massive data can be divided into smaller data packets and broken into pieces. In the process of data extraction, the data can be extracted directly from the data packets, which makes parallel processing easier and greatly reduces the computing power of the automatic driving system. In the process of digging valuable data, the parallel processing of the server 10 can greatly improve efficiency of data digging.

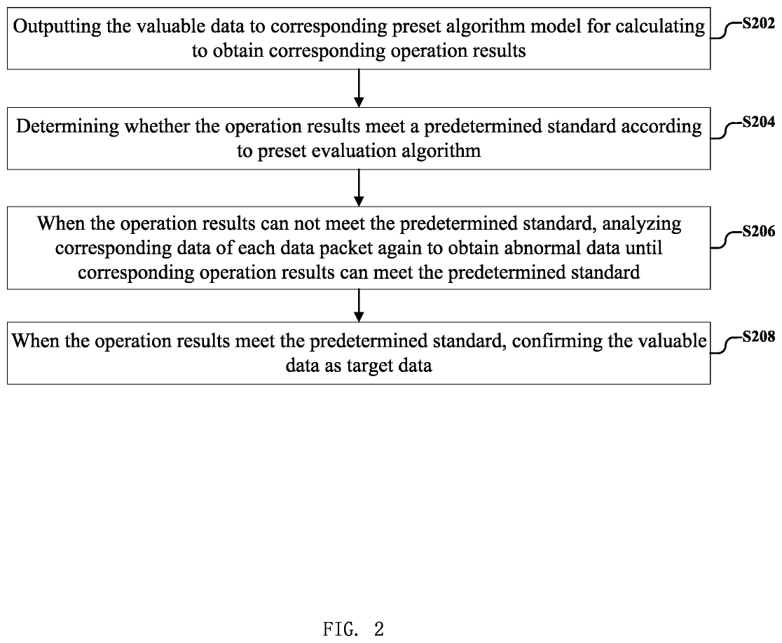

Referring to FIG. 2, FIG. 2 illustrates a flow diagram of a method of digging valuable data in accordance with a second embodiment. The second embodiment of the method further includes the following steps.

In step S202, the valuable data is output to corresponding preset algorithm model for calculating to obtain corresponding operation results. Specifically, the preset algorithm model is algorithm model required by the automatic driving system, including but not limited to perception model, decision model, prediction model, etc. . The prediction model includes but is not limited to traffic light recognition model used to identify status of traffic lights, moving target trajectory prediction model used to predict trajectory of moving objects, etc. . The preset algorithm model can be the algorithm model related to autonomous driving technology, which will not be listed here.

In step S204, it is determined that whether the operation results meet a predetermined standard according to preset evaluation algorithm. Specifically, the preset evaluation algorithm can evaluate accuracy rate, recall rate and error rate of the preset algorithm model.

For example, it is assumed that predetermined standard is that output data with traffic light abnormal labels in the traffic light recognition model accounts for 90% or more of the total data. In order to evaluate the accuracy rate of data with traffic light recognition anomalies, the data with traffic light recognition anomalies is input into the traffic light recognition model. If the output data with traffic light abnormal labels in the traffic light recognition model accounts for 95% of the total data, this output data is considered to meet the preset standards. If the output data with traffic light abnormal labels in the traffic light recognition model accounts for 70% of the total data, this output data is considered does not meet the predetermined standards.

In step S206, when the operation results can not meet the predetermined standard, corresponding data of each data packets is analyzed again to obtain abnormal data until corresponding operation results can meet the predetermined standard. It is understandable that when the operation results output by the traffic light recognition model for the first time does not meet the predetermined standard, the abnormal data in each packets needs to be re-labeled before inputting into the traffic light recognition model, and then new data with the traffic light abnormal recognition label is input into the traffic light recognition model for calculation to obtain second operation result. If the second operation result output by the model still does not meet the predetermined standard, the abnormal data in each packet needs to be re-labeled again before inputting into the traffic light recognition model, and then new data with the traffic light abnormal recognition label is input into the traffic light recognition model for calculation to obtain third operation result until the operation result meets the predetermined standard.

In step S208, when the operation results meet the predetermined standard, the valuable data is confirmed as target data. Understandably, when the accuracy rate of the operation results obtained by the traffic light recognition model of version data reaches 90% or above, it means that the version data can make the accuracy rate of the traffic light recognition model meet the predetermined standard. Therefore, the version data is considered as the target data that can make the accuracy rate of the traffic light recognition model meet the predetermined standard.

In the above embodiment, by putting the data into the model for training and reaching the predetermined standard to get the target data, the target data can be extracted from the massive data to train the model.

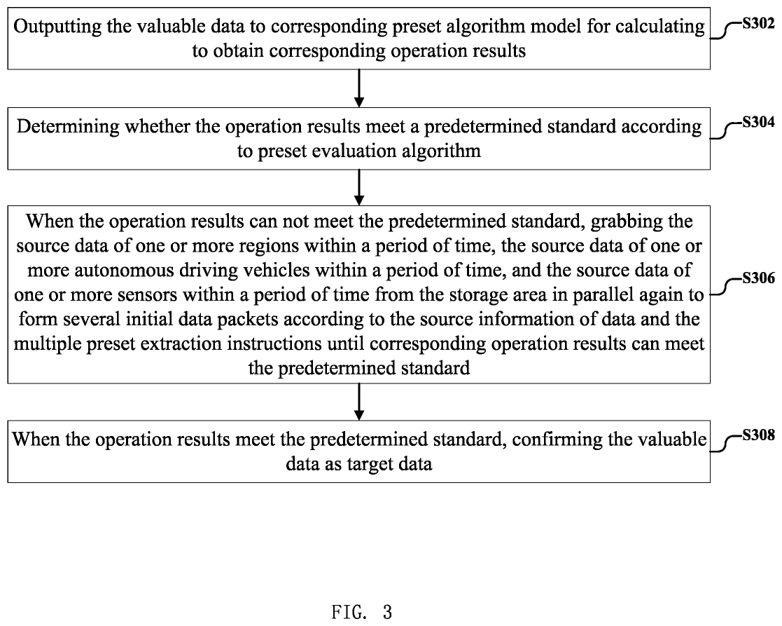

Referring to FIG. 3, FIG. 3 illustrates a flow diagram of a method of digging valuable data in accordance with a third embodiment. The third embodiment of the method further includes the following steps.

In step S302, the valuable data is outputted to corresponding preset algorithm model for calculating to obtain corresponding operation results.

In step S304, it is determined that whether the operation results meet a predetermined standard according to preset evaluation algorithm.

In step S306, when the operation results can not meet the predetermined standard, according to the source information of data and the multiple preset extraction instructions, the source data of one or more regions within a period of time, the source data of one or more autonomous driving vehicles within a period of time, and the source data of one or more sensors within a period of time from the storage area 1 of the source data is grabbed in parallel again to form several initial data packets until corresponding operation results can meet the predetermined standard.

For example, image information collected by the remote radar of vehicle A is input into image recognition model for calculation. If the operation results show that data amount is insufficient for model transition fitting, and number of images needs to be increased for calculation of the image recognition model. Then, according to extraction instruction, image data collected by the remote radar of vehicle A and image data collected by the camera of vehicle A are obtained from the source data storage area, and the image data is packaged into data packets and sent to the server 10. The server 10 parses the data packets and inputs the data into the image recognition model for second calculation. If second operation result of the image recognition model still does not meet the predetermined standard, the data need to be obtained again according to the extraction instruction and input into the image recognition model for calculation until the operation result meets the predetermined standard.

In step S308, when the operation results meet the predetermined standard, the valuable data is confirmed as target data.

In the above embodiment, according to the extraction instructions, the data is filtered from the storage area of the source data to train the model and get the target data, so that the data can be used more flexibly to train the model.

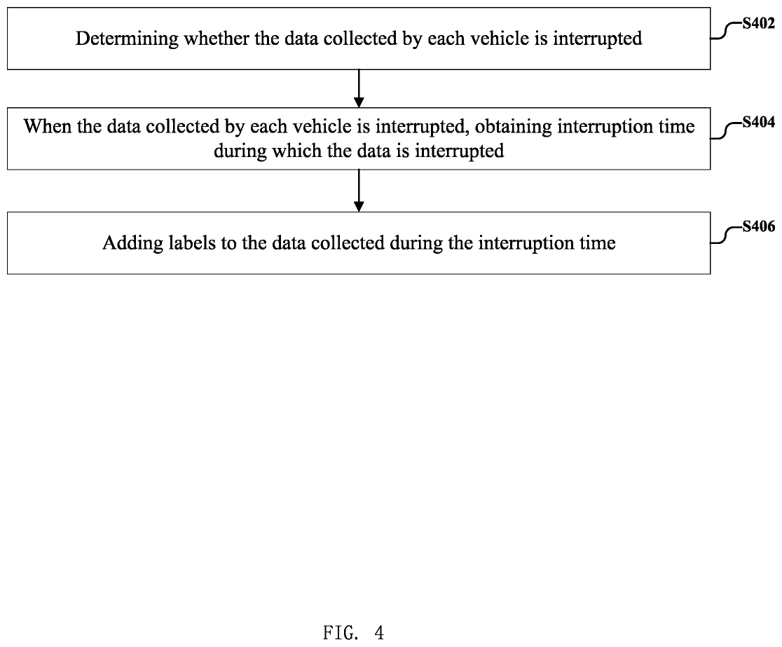

Referring to FIG. 4, FIG. 4 illustrates a sub flow diagram of a method of digging valuable data in accordance with the second embodiment. In the second embodiment, adding labels to the abnormal data includes the following steps.

In step S402, it is determined that whether the data collected by each vehicle is interrupted.

For example, the remote radar packages the data it collects and sends it to the server 10. The server 10 parses the data packets transmitted by the remote radar and analyzes parsed data. When analysis process is interrupted, it means that the data collected by vehicles is interrupted.

In step S404, when the data collected by each vehicle is interrupted, interruption time during which the data is interrupted is obtained.

For example, if there is only a period of data interruption in the data packets, start time and end time of that period are obtained. If multiple segments of data are interrupted in the data packets, the start time and end time of each segment of interruption time are obtained. The multi-segment interrupted data is consolidated into one packet and the start time of the first segment and the end time of the last segment are obtained.

In step S406, labels are added to the data collected during the interruption time.

For example, if there is only a period of data interruption in the data packets and the interruption time is obtained, the time is labeled as the interruption of remote radar acquisition data and the time when the data is labeled is included. If multiple segments of data are interrupted and the data is integrated into a data packet, the data packet will be labeled as the interruption of remote radar acquisition information, and the time of labeling the data packet will be included.

In the above embodiment, analyzes and labels the interrupted data, and attach the label time. In this way, the interrupted data of corresponding device can be found quickly from the massive data. According to the label time, the interrupted data of corresponding time can be found too.

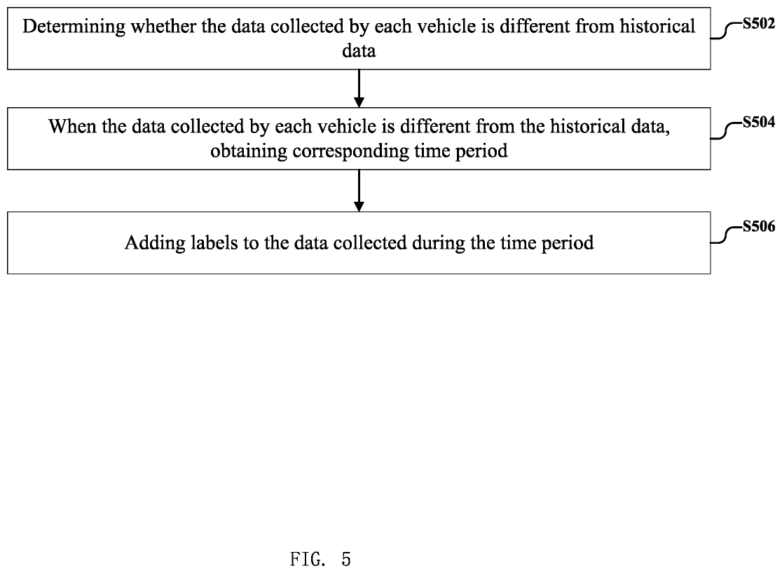

Referring to FIG. 5, FIG. 5 illustrates a sub flow diagram of a method of digging valuable data in accordance with the third embodiment. In the third embodiment, adding labels to the abnormal data includes the following steps.

In step S502, it is determined that whether the data collected by each vehicle is different from historical data.

For example, the server 10 gets traffic light identification data collected by vehicles from 9 a.m. to 12 a.m. today. The server 10 retrievals traffic light identification historical data from 9 a.m. to 12 a.m., and compares data collected by the vehicles with the historical data. If the traffic light identification data collected by the vehicles shows that the vehicles recognizes one less traffic light at 10 a.m., it is considered that the traffic light identification data collected by the vehicles from 9 a.m. to 12 a.m. is different from the traffic light identification historical data from 9 a.m. to 12 a.m.. The server 10 can also retrieval corresponding historical data according to version set by the users, in order to analyze the traffic light identification data collected from 9 a.m. to 12 a.m. to determine whether there is any difference.

In step S504, when the data collected by each vehicle is different from the historical data, corresponding time period is obtained.

For example, when the server 10 compared and analyzed current traffic light recognition data from 9 a.m. to 12 a.m. with the historical data from 9 a.m. to 12 a.m., the server 10 finds that current data recognized one less traffic light at 10 a.m. compared with the historical data. The server 10 obtains time from the beginning to the end of the identification of a traffic light in the data of less than one traffic light. If the current traffic light recognition data obtained from 9 a.m. to 12 a.m., and the historical traffic light recognition data obtained from 9 a.m. to 12 a.m., are compared and analyzed, and it is found that the traffic light information in the data of several segments with less traffic light recognition is green, while the traffic light information in the corresponding historical data is red, the data of less traffic light recognition can be integrated into a data package. And the start time and end time of each section of less recognition traffic light data are obtained. At the same time, the start time of the first less recognized traffic light data and the end time of the last less recognized traffic light data in a data packet can also be obtained.

In step S506, labels are added to the data collected during the time period.

For example, compared with the historical traffic light recognition data obtained from 9 a.m. to 12 a.m., the current traffic light recognition data obtained from 9 a.m. to 12 a.m., one less traffic light data was identified at 10 a.m., and the data corresponding to this period of time will be labeled as identifying traffic light anomalies. And the time of labeling will be attached. Similarly, if there are multiple segments of the same traffic lights that identify traffic lights and integrated into a data packet, the data packet will be labeled with the identification of traffic light anomalies, and the time of labeling the data packet will be attached.

In the above embodiment, by comparing data to find differences between data, it is easier and faster to find abnormal blind spots in a large number of the same data, and to find the abnormal data at the corresponding time according to the labeling time.

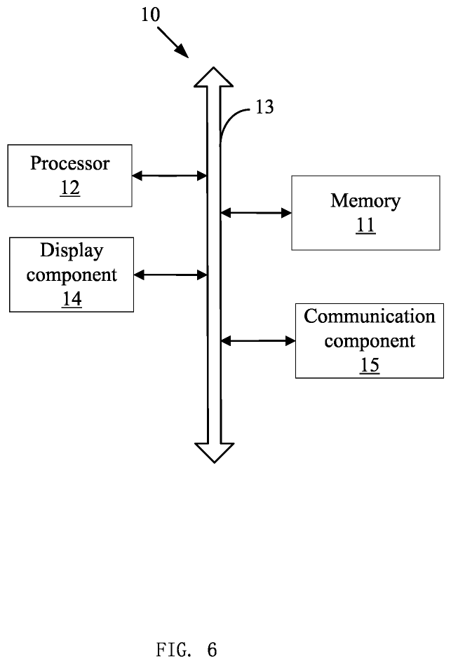

Referring to FIG. 6, FIG. 6 illustrates a schematic diagram of a server in accordance with an embodiment. The server 10 includes a memory 11, a processor 12, and a bus 13. In this embodiment, the memory 11 configured to store program instructions. The processor 12 configured to execute the program instructions to enable the server 10 to perform method of digging valuable data.

The memory 11 includes at least one type of readable storage medium, which includes flash memory, hard disk, multimedia card, card-type memory (for example, SD or DX memory, etc.), magnetic memory, disk, optical disc, etc. Memory 11 in some embodiments may be an internal storage unit of a computer device, such as a hard disk of a computer device. Memory 11, in other embodiments, can also be a storage device for external computer devices, such as a plug-in hard disk, a Smart Media Card (SMC), a Secure Digital (SD) Card, a Flash Card, etc. equipped on a computer device. Further, the memory 11 may include both the internal and external storage units of a computer device. The memory 11 can not only be used to store the application software and all kinds of data installed in the computer equipment, such as the code to realize the method of digging valuable data, but also can be used to temporarily store the data that has been output or will be output.

The processor 12, in some embodiments, may be a Central Processing Unit (CPU), controller, microcontroller, microprocessor, or other data processing chip used to run the program instructions stored in the memory 11 that control the server 10 to realize the method of digging valuable data.

The bus 13 can be either a peripheral component interconnect (PCI) bus or an extended industry standard architecture (EISA) bus. The bus can be divided into address bus, data bus, control bus and so on. For ease of representation, FIG. 6 is represented by a single thick line, but does not indicate that there is only one bus or one type of bus.

Further, the server 10 may also include a display component 14. The display component 14 can be LED (Light Emitting Diode) display, LCD display, touch LCD display and OLED (Organic Light-Emitting Diode) touchscreen, etc. The display component 14 may also be appropriately called the display device or display unit for displaying the information processed in the server 10 and for displaying the visual user interface.

Further, the server 10 may also include a communication component 15. Optionally, the communication component 15 may include a wired communication component and/or a wireless communication component (for example, a WI-FI communication component, a Bluetooth communication component, etc.), which is usually used to establish a communication connection between the server 10 and other computer devices.

FIG. 6 shows the server 10 only with components 11-15. To the understanding of technicians in this field, the structure shown in FIG. 6 does not constitute a qualification for the server 10, which may include fewer or more components than illustrated, or some combination of components, or a different arrangement of components.

It should be noted that the embodiments number of this disclosure above is for description only and do not represent the advantages or disadvantages of embodiments. And in this disclosure, the term “including”, “include” or any other variants is intended to cover a non-exclusive contain. So that the process, the devices, the items, or the methods includes a series of elements not only include those elements, but also include other elements not clearly listed, or also include the inherent elements of this process, devices, items, or methods. In the absence of further limitations, the elements limited by the sentence “including a . . . ” do not preclude the existence of other similar elements in the process, devices, items, or methods that include the elements.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

1. A method of digging valuable data, applying to an autonomous driving system, the autonomous driving system comprises a plurality of autonomous driving vehicles, the method comprising:
receiving source data sent by all the autonomous driving vehicles of the autonomous driving system, and storing the source data in storage area, the source data comprising collecting data collected by all the autonomous driving vehicles, running status data generated by all the autonomous driving vehicles during road testing, and processing data calculated by all the autonomous driving vehicles, the collecting data being collected by multiple sensors of each autonomous driving vehicle, the source data from different sources having different data structure attributes, the data structure attributes including source information of data, the source information of data including area identifier indicating geographic area of the autonomous driving vehicles, vehicle identifier indicating identity of the autonomous driving vehicles, sensor identifier indicating identity of the sensors, and timestamp of the source data;
grabbing the source data of one or more regions within a period of time, the source data of one or more autonomous driving vehicles within a period of time, and the source data of one or more sensors within a period of time from the storage area in parallel to form several initial data packets, according to the source information of data and multiple preset extraction instructions;
analyzing corresponding data in each initial data packet to obtain abnormal data;
adding labels to the abnormal data to form first version data packets, each of the first version data packets includes a first timestamp;
when receiving label requests sent by one or more clients, adding labels to data associated with the label requests in some of the initial data packets to form second version data packets, according to the label requests, each of the second version data packets includes a second timestamp, the second timestamp indicating time of adding labels to the some of the initial data packets;
when receiving data analysis requests sent by one or more clients, analyzing the data analysis requests in parallel to obtain corresponding labels, the data analysis requests including presentation information of the labels; and
obtaining data from the first version data packets and/or the second version data packets in parallel to be valuable data according to the labels obtained.

2. The method as claimed in claim 1, wherein the data analysis requests include requests to extract data from vehicles in one area, requests to obtain data from multiple vehicles, requests to obtain data from multiple computing modules of a vehicle, and requests to obtain data from multiple sensors of a vehicle;
wherein obtaining data from the first version data packets and/or the second version data packets in parallel to be valuable data according to the labels obtained comprises:
simultaneously obtaining the valuable data from one or more data packets required by different data analysis requests, and sending the valuable data obtained to corresponding clients.

3. The method as claimed in claim 1, wherein the several initial data packets comprises area initial data packets, vehicle initial data packets and sensor initial data packets, the area initial data packets, the vehicle initial data packets and the sensor initial data packets are expressed by storage path IDs of the source data, each the storage path ID includes source data storage path ID of the sensor, or processing data storage path ID of the vehicle.

4. The method as claimed in claim 3, wherein obtaining data from the first version data packets and/or the second version data packets in parallel to be valuable data according to the labels obtained comprises:
obtaining corresponding storage path IDs of the source data according to the labels; and
obtaining corresponding data from the first version data packets or the second version data packets according to the storage path IDs of the source data.

5. The method as claimed in claim 3, wherein the area initial data packets, the vehicle initial data packets and the sensor initial data packets have storage path IDs respectively, and the area initial data packets, the vehicle initial data packets and the sensor initial data packets store corresponding source data respectively.

6. The method as claimed in claim 1, further comprising:
outputting the valuable data to corresponding preset algorithm model for calculating to obtain corresponding operation results;
determining whether the operation results meet a predetermined standard according to preset evaluation algorithm;
when the operation results can not meet the predetermined standard, analyzing corresponding data of each data packet again to obtain abnormal data until corresponding operation results can meet the predetermined standard; and
when the operation results meet the predetermined standard, confirming the valuable data as target data.

7. The method as claimed in claim 1, further comprising:
outputting the valuable data to corresponding preset algorithm model for calculating to obtain corresponding operation results;
determining whether the operation results meet a predetermined standard according to preset evaluation algorithm;
when the operation results can not meet the predetermined standard, grabbing the source data of one or more regions within a period of time, the source data of one or more autonomous driving vehicles within a period of time, and the source data of one or more sensors within a period of time from the storage area in parallel again to form several initial data packets according to the source information of data and the multiple preset extraction instructions until corresponding operation results can meet the predetermined standard; and
when the operation results meet the predetermined standard, confirming the valuable data as target data.

8. The method as claimed in claim 1, wherein adding labels to the abnormal data to form first version data packets comprises:
determining whether the data collected by each vehicle is interrupted;
when the data collected by each vehicle is interrupted, obtaining interruption time during which the data is interrupted; and
adding labels to the data collected during the interruption time.

9. The method as claimed in claim 1, wherein adding labels to the abnormal data to form first version data packets comprises:
determining whether the data collected by each vehicle is different from historical data;
when the data collected by each vehicle is different from the historical data, obtaining corresponding time period; and
adding labels to the data collected during the time period.

10. A server of digging valuable data, comprising:
a memory configured to store program instructions; and
a processor configured to execute the program instructions to enable the server to perform a method of digging valuable data, wherein the method applies to an autonomous driving system, the autonomous driving system comprises a plurality of autonomous driving vehicles, wherein the method comprises:
receiving source data sent by all the autonomous driving vehicles of the autonomous driving system, and storing the source data in storage area, the source data comprising collecting data collected by all the autonomous driving vehicles, running status data generated by all the autonomous driving vehicles during road testing, and processing data calculated by all the autonomous driving vehicles, the collecting data being collected by multiple sensors of each autonomous driving vehicle, the source data from different sources having different data structure attributes, the data structure attributes including source information of data, the source information of data including area identifier indicating geographic area of the autonomous driving vehicles, vehicle identifier indicating identity of the autonomous driving vehicles, sensor identifier indicating identity of the sensors, and timestamp of the source data;
grabbing the source data of one or more regions within a period of time, the source data of one or more autonomous driving vehicles within a period of time, and the source data of one or more sensors within a period of time from the storage area in parallel to form several initial data packets, according to the source information of data and multiple preset extraction instructions;
analyzing corresponding data in each initial data packet to obtain abnormal data;
adding labels to the abnormal data to form first version data packets, each of the first version data packets includes a first timestamp;
when receiving label requests sent by one or more clients, adding labels to data associated with the label requests in some of the initial data packets to form second version data packets, according to the label requests, each of the second version data packets includes a second timestamp, the second timestamp indicating time of adding labels to the some of the initial data packets;
when receiving data analysis requests sent by one or more clients, analyzing the data analysis requests in parallel to obtain corresponding labels, the data analysis requests including presentation information of the labels; and
obtaining data from the first version data packets and/or the second version data packets in parallel to be valuable data according to the labels obtained.

11. The server as claimed in claim 10, wherein the data analysis requests include requests to extract data from vehicles in one area, requests to obtain data from multiple vehicles, requests to obtain data from multiple computing modules of a vehicle, and requests to obtain data from multiple sensors of a vehicle;
wherein obtaining data from the first version data packets and/or the second version data packets in parallel to be valuable data according to the labels obtained comprises:
simultaneously obtaining the valuable data from one or more data packets required by different data analysis requests, and sending the valuable data obtained to corresponding clients.

12. The server as claimed in claim 10, wherein the several initial data packets comprises area initial data packets, vehicle initial data packets and sensor initial data packets, the area initial data packets, the vehicle initial data packets and the sensor initial data packets are expressed by storage path IDs of the source data, each the storage path ID includes source data storage path ID of the sensor, or processing data storage path ID of the vehicle.

13. The server as claimed in claim 12, wherein obtaining data from the first version data packets and/or the second version data packets in parallel to be valuable data according to the labels obtained comprises:
obtaining corresponding storage path IDs of the source data according to the labels; and
obtaining corresponding data from the first version data packets or the second version data packets according to the storage path IDs of the source data.

14. The server as claimed in claim 12, wherein the area initial data packets, the vehicle initial data packets and the sensor initial data packets have storage path IDs respectively, and the area initial data packets, the vehicle initial data packets and the sensor initial data packets store corresponding source data respectively.

15. The server as claimed in claim 10, further comprising:
outputting the valuable data to corresponding preset algorithm model for calculating to obtain corresponding operation results;
determining whether the operation results meet a predetermined standard according to preset evaluation algorithm;
when the operation results can not meet the predetermined standard, analyzing corresponding data of each data packet again to obtain abnormal data until corresponding operation results can meet the predetermined standard; and
when the operation results meet the predetermined standard, confirming the valuable data as target data.

16. The server as claimed in claim 10, further comprising:
outputting the valuable data to corresponding preset algorithm model for calculating to obtain corresponding operation results;
determining whether the operation results meet a predetermined standard according to preset evaluation algorithm;
when the operation results can not meet the predetermined standard, grabbing the source data of one or more regions within a period of time, the source data of one or more autonomous driving vehicles within a period of time, and the source data of one or more sensors within a period of time from the storage area in parallel again to form several initial data packets according to the source information of data and the multiple preset extraction instructions until corresponding operation results can meet the predetermined standard; and
when the operation results meet the predetermined standard, confirming the valuable data as target data.

17. The server as claimed in claim 10, wherein adding labels to the abnormal data to form first version data packets comprises:
determining whether the data collected by each vehicle is interrupted;
when the data collected by each vehicle is interrupted, obtaining interruption time during which the data is interrupted; and
adding labels to the data collected during the interruption time.

18. The server as claimed in 10, wherein adding labels to the abnormal data to form first version data packets comprises:
determining whether the data collected by each vehicle is different from historical data;
when the data collected by each vehicle is different from the historical data, obtaining corresponding time period; and
adding labels to the data collected during the time period.

19. A system of digging valuable data, comprising:
a plurality of autonomous driving vehicle; and
a server, comprising:
a memory configured to store program instructions; and
a processor configured to execute the program instructions to enable the server to perform a method of digging valuable data, wherein the method applies to an autonomous driving system, the autonomous driving system comprises a plurality of autonomous driving vehicles, wherein the method comprises:
receiving source data sent by all the autonomous driving vehicles of the autonomous driving system, and storing the source data in storage area, the source data comprising collecting data collected by all the autonomous driving vehicles, running status data generated by all the autonomous driving vehicles during road testing, and processing data calculated by all the autonomous driving vehicles, the collecting data being collected by multiple sensors of each autonomous driving vehicle, the source data from different sources having different data structure attributes, the data structure attributes including source information of data, the source information of data including area identifier indicating geographic area of the autonomous driving vehicles, vehicle identifier indicating identity of the autonomous driving vehicles, sensor identifier indicating identity of the sensors, and timestamp of the source data;
grabbing the source data of one or more regions within a period of time, the source data of one or more autonomous driving vehicles within a period of time, and the source data of one or more sensors within a period of time from the storage area in parallel to form several initial data packets, according to the source information of data and multiple preset extraction instructions;
analyzing corresponding data in each initial data packet to obtain abnormal data;
adding labels to the abnormal data to form first version data packets, each of the first version data packets includes a first timestamp;
when receiving label requests sent by one or more clients, adding labels to data associated with the label requests in some of the initial data packets to form second version data packets, according to the label requests, each of the second version data packets includes a second timestamp, the second timestamp indicating time of adding labels to the some of the initial data packets;
when receiving data analysis requests sent by one or more clients, analyzing the data analysis requests in parallel to obtain corresponding labels, the data analysis requests including presentation information of the labels; and
obtaining data from the first version data packets and/or the second version data packets in parallel to be valuable data according to the labels obtained.

20. The system as claimed in claim 19, further comprising:
outputting the valuable data to corresponding preset algorithm model for calculating to obtain corresponding operation results;
determining whether the operation results meet a predetermined standard according to preset evaluation algorithm;
when the operation results can not meet the predetermined standard, grabbing the source data of one or more regions within a period of time, the source data of one or more autonomous driving vehicles within a period of time, and the source data of one or more sensors within a period of time from the storage area in parallel again to form several initial data packets according to the source information of data and the multiple preset extraction instructions until corresponding operation results can meet the predetermined standard; and
when the operation results meet the predetermined standard, confirming the valuable data as target data.
